(19) United States
(12) Patent Application Publication
(10) Pub. No.: US 2014/0287315 A1
(43) Pub. Date: Sep. 25, 2014

(54) Si/C COMPOSITES AS ANODE MATERIALS FOR LITHIUM ION BATTERIES

(71) Applicant: Wacker Chemie AG, Muenchen (DE)

(72) Inventors: Dennis TROEGEL, Maisach (DE); Manfred AMANN, Odelzhausen (DE); Stefan HAUFE, Neubiberg (DE); Jelena PANTELIC, Germering (DE)

(73) Assignee: Wacker Chemie AG, Muenchen (DE)

(21) Appl. No.: 14/212,377

(22) Filed: Mar. 14, 2014

(30) Foreign Application Priority Data
Mar. 19, 2013 (DE) 10 2013 204 799.1

(51) Int. Cl. H01M 4/134; H01M 4/133; H01M 4/04

(52) U.S. Cl. CPC H01M 4/134; H01M 4/0471; H01M 4/133; H01M 4/0404; H01M 4/0428; H01M 4/0421; H01M 2004/027
USPC 429/231.8; 252/502; 252/503; 427/122; 427/113

(57) ABSTRACT

The invention relates to a process for producing an Si/C composite, which includes providing an active material containing silicon, providing lignin, bringing the active material into contact with a C precursor containing lignin and carbonizing the active material by converting lignin into inorganic carbon at a temperature of at least 400° C. in an inert gas atmosphere. The invention further provides an Si/C composite, the use thereof as anode material in lithium ion batteries, an anode material for lithium ion batteries which contains such an Si/C composite, a process for producing an anode for a lithium ion battery, in which such an anode material is used, and also a lithium ion battery which includes an anode having an anode material according to the invention.

### BACKGROUND OF THE INVENTION

The invention relates to an Si/C composite, a process for producing it and its use as anode active material in lithium ion batteries.

In anodes for lithium ion batteries, in which the electrode active material is based on silicon (as material having the highest known storage capacity for lithium ions; 4199 mAh/g), the silicon can experience an extreme volume change of up to about 300% on charging with lithium and discharging. This volume change results in high mechanical stressing of the active material and the total electrode structure, which leads, by electrochemical milling, to a loss of electrical contacting and thus to destruction of the electrode accompanied by a loss of capacity. Furthermore, the surface of the silicon anode material used reacts with constituents of the electrolyte so as to continuously form passivating protective layers (Solid Electrolyte Interface; SEI), which leads to an irreversible loss of lithium.

To solve these problems which are specifically known for Si-based anodes, various approaches for electrochemical stabilization of Si-based electrode active materials have been pursued in the last ten years (an overview is given by A. J. Appleby et al., J. Power Sources 2007, 163, 1003-1039).

One possible solution is to use the silicon-based active material not in pure form but as composite with carbon.

Graphite and structurally related carbons are relatively soft, have very good electrical conductivity, have a low mass and undergo a small volume change on charging/discharging. For these reasons, carbon-based anodes have, as is known, a very good electrochemical stability. As a result of combining the advantages of the two elements (Si with large capacity, C with high stability), Si/C-based electrode active materials have an increased capacity together with a more stable cycling behavior than pure silicon.

Such Si/C composites can be produced by chemical vapor deposition of carbon on silicon, as described in EP 1363341 A2.

It is likewise known that these can be produced by reactive milling of silicon with carbon and subsequent carbonization, see, for example, US 20040137327 A1.

Embedding silicon particles in a matrix of C-containing particles with subsequent carbonization also leads to Si/C composites, cf. US 20050136330 A1. Both the Si-containing particles and the C-containing particles are firstly coated. After embedding of the Si particles, the Si/C composites are coated. The coated Si/C composites are subsequently subjected to an oxidation reaction. As coating material, preference is given to C precursors which react with an oxidant and those which have a high melting point and give a high C yield on decomposition. US 20050136330 A1 mentions, by way of example, heavy aromatic oil residues, pitch from chemical processes, lignin from the pulp industry, phenolic resins, carbohydrates such as sugar and polyacrylonitrile. A disadvantage of this process is, in particular, a reduction in the electrochemical capacity of the resulting Si/C composites due to partial deactivation of the silicon. The oxidation reaction which occurs partly converts the silicon present into (electrochemically inactive) Si oxides which reduce the content of active silicon and thus the capacity of the total composite.

WO 2009155414 A1 discloses a process for producing metal-carbon composites. The metal is selected from the group consisting of Sb, Li, Rb, Ti, V, Mn, Fe, Co, Ni, Cu, Zn, Zr, Mo, Ru, Rh, Pd, Ag, W, Ir, Pt, Au and combinations thereof.

The C precursor is selected from the group consisting of lignin, ammonium derivatives of lignin, alkali metal lignosulfonate, tannin, tanninsulfonate, asphalt, sulfonated asphalt, wood, sawdust, cane sugar, lactose, cellulose, starch, polysaccharide, organic wastes, pitch or tars from oil or coal.

Possible C precursors are, in particular, hydrocarbons, carbohydrates and many polymers which, depending on their composition and structure, lead to graphitizable carbons (soft carbon) or nongraphitizable carbons (hard carbon).

Furthermore, C precursors which are based on vegetable raw materials and already have an intrinsic silicon content (at least 5% by weight of Si; e.g. reed, rice hulls, sea grass) and on carbonization lead to porous carbons having Si contents of less than 1% by weight are known and have been described, cf. US 20100069507 A1.

WO 2011006698 A1 discloses a process for producing a nanostructured silicon-carbon composite, in which a monohydroxyaromatic and/or polyhydroxyaromatic compound, an aldehyde and a catalyst are reacted and nanosize silicon powder is added, and carbonization subsequently takes place. The C precursor can be catechol, resorcinol, phloroglucinol, hydroquinone, phenol or a mixture of these compounds. The result is a nanostructured silicon-carbon composite which has an average particle size of less than 40 μm, a mesopore volume of from 0.005 to 3 cm³/g, a carbon content of from 20 to 99% by weight and a proportion of the inorganic phase of from 1 to 80% by weight.

Disadvantages of the process mentioned are firstly that the monohydroxyaromatic and/or polyhydroxyaromatic starting materials used have a petrochemical origin and thus have to be considered to be critical in the long term from the point of view of sustainability. Secondly, the production process involving polymerizing nanosize silicon powder into an organic resin matrix has an increased time and energy requirement, whereas other processes proceeding from fully polymerized starting materials no longer require this additional time.

C precursors which contain aromatic units in their molecular structure, are highly crosslinked and bear no or only few oxygen-containing chemical groups are advantageous since on carbonization they lead in high yields to mechanically very stable carbons having a low oxygen content. This makes it possible to obtain Si/C composites in which the silicon is present embedded in a well-crosslinked, mechanically stable and conductive carbon matrix and oxidation of the silicon surface by oxygen is very substantially minimized. Although large changes in the volume of the Si particles occur during cyclization or during the charging/discharging process, the embedding of these Si particles in the carbon matrix is maintained in such a composite.

### DESCRIPTION OF THE INVENTION

These problems have led to the object of the invention.

The object of the invention is achieved by a process for producing an Si/C composite and by an Si/C composite of the invention.

The invention also provides an anode material which contains such an Si/C composite.

The object is also achieved by a process for producing an anode for a lithium ion battery, in which the anode material of the invention is used.

Finally, the invention also provides a lithium ion battery which comprises an anode having an anode material of the invention.

To produce an Si/C composite according to the present invention, a silicon-based active material is used.

This can be elemental silicon, a silicon oxide or a silicon-metal alloy. Preference is given to using elemental silicon since this has the greatest storage capacity for lithium ions.

The silicon-based active material is preferably used in particulate form, which can be microsize or nanosize.

Particular preference is given to nanosize Si particles having an average particle size of <500 nm, which can be present in crystalline or amorphous form.

Apart from Si-based, spherical particles, the Si-based active material can also be present in linear form with a fiber structure or in the form of Si-containing films or coatings.

The silicon-based active material can consist of high-purity polysilicon, silicon with targeted doping or else metallurgical silicon which can have elemental contamination.

Furthermore, it can be deliberately or coincidentally alloyed with other metals and elements in the form of silicides, e.g. with Li, Sn, Ca, Co, Ni, Cu, Cr, Ti, Al, Fe, etc. These alloys can be binary, ternary or multinary.

The silicon-based active material used can also be chemically modified on the surface either coincidentally as a result of the process or else deliberately. Typical surface functionalities can be: Si—H, Si—Cl, Si—OH, Si—O-alkyl, Si—O-aryl, Si-alkyl, Si-aryl, Si—O-silyl. The groups bound to the surface can also contain functional groups and can be either monomeric or polymeric. They can be bound to the Si surface only at one or more chains of the molecule or can bridge a plurality of Si particles.

Apart from the Si-based active material, further active materials can also perfectly well be present in the Si/C composite materials of the invention.

These can consist of a carbon modification (especially graphite, carbon black, amorphous carbon, pyrolytic carbon, soft carbon, hard carbon, carbon nanotubes (CNTs), fullerenes, graphene) or of another active material such as (embodiments not restricted to the examples mentioned) Li, Sn, Mg, Ag, Co, Ni, Zn, Cu, Ti, B, Sb, Al, Pb, Ge, Bi, rare earths or combinations thereof. In addition, further components based on an electrochemically inactive material based on metals (e.g. copper), oxides, carbides or nitrides can be present in the composite.

Lignin is a macromolecular highly branched polyphenol having a complex structure analogous to phenol- or resorcinol-formaldehyde resins.

For the purposes of the present invention, the term lignin covers all three-dimensional and amorphous polymeric networks made up of the three aromatic basic building blocks of para-coumaryl alcohol, coniferyl alcohol and sinapyl alcohol, which can be linked to one another in a variety of forms.

Natural lignin is a constituent of many vegetable organisms and can be obtained, for example, from coniferous timbers, timbers from broad-leafed trees, grasses or other vegetable raw materials.

Lignin can also have been synthesized chemically from appropriate precursors.

The lignin from vegetable raw materials can be obtained by digestion processes from lignocellulose.

Typical industrial digestion processes are the sulfate process, the sulfite process, various wood saccharification or solvent methods (Organosolv or Aquasolv processes), which are practiced in numerous modifications.

The lignin can be used in pure form or as derivative, for example as lignosulfonate, or as metal lignosulfonate.

Apart from lignin, further C precursors can also be introduced, in admixture or separately in succession, into the composite.

These possible precursors can be (but are not limited to the groups of materials mentioned): elemental carbon (especially carbon blacks, graphites, charcoals, cokes, carbon fibers, fullerenes, graphene, etc.), simple hydrocarbons (e.g. methane, ethane, ethylene, acetylene, propane, propylene, butane, butene, pentane, isobutane, hexane, benzene, toluene, styrene, ethylbenzene, diphenylmethane, naphthalene, phenol, cresol, nitrobenzene, chlorobenzene, pyridine, anthracene, phenanthrene, etc.), polyaromatic hydrocarbons and hydrocarbon mixtures (especially pitches and tars: mesogenic pitch, mesophase pitch, petroleum pitch, hard coal tar pitch, etc.), organic acids (especially citric acid), alcohols (especially ethanol, propanol, furfuryl alcohol, etc.), carbohydrates (especially glucose, sucrose, lactose, cellulose, starch, including monosaccharides, oligosaccharides and polysaccharides), organic polymers (especially epoxy resins, phenol-formaldehyde resin, resorcinol-formaldehyde resin, polyethylene, polystyrene, polyvinyl chloride, polyvinylidene chloride, polyvinylidene fluoride, polytetrafluoroethylene, polyvinyl acetate, polyvinyl alcohol, polyethylene oxide, polyacrylonitrile, polyaniline, polybenzimidazole, polydopamine, polypyrrole, poly-para-phenylene), silicones.

The C precursors can be present in admixture, in molecularly linked form (e.g. copolymers) or else separately beside one another in the composite structure.

Coating of the silicon-based active material with lignin and optionally other C precursors and embedding of the silicon-based active material in a lignin-containing matrix can be effected in various ways.

The silicon-based active material can be subjected to high-energy milling together with lignin (dry or with water or organic solvent) or be physically mixed in any form with lignin.

Furthermore, the silicon-based active material can be dispersed in a dispersion or solution of lignin and coated with lignin or embedded in lignin by subsequent removal of the solvent.

This can be brought about by removal of the solvent under reduced pressure or by precipitation of Si/lignin and subsequent filtration or centrifugation.

The processes in the liquid phase are to be preferred since they enable the best distribution of silicon in lignin to be achieved.

Furthermore, the silicon-based active material can be processed directly in lignin solutions as are obtained, for example, in the Organosolv process.

The silicon/lignin composites obtained in this way can be reacted further in moist form or after drying.

The intermediates can also be subsequently milled before further processing or be subjected to coating/embedding with further C precursors.

Another possibility is to deposit silicon nanoparticles from the gas phase onto lignin by means of CVD or TVD processes or to deposit C precursors from the gas phase on the Si-based active material.

The conversion of lignin and optionally other C precursors into inorganic carbon for producing the Si/C composites of the invention is preferably brought about thermally by anaerobic carbonization; this process can take place, for example, in a tube furnace, rotary tube furnace or a fluidized-bed reactor.

The choice of reactor type preferably depends on whether the carbonization is intended to be carried out statically or with continuous mixing of the reaction medium.

The carbonization can be carried out at temperatures in the range from 400 to 1400° C., preferably 500-1000° C. and particularly preferably 700-900° C.

The atmosphere used consists of an inert gas such as nitrogen or argon, preferably argon, to which further proportions of a reducing gas such as hydrogen can optionally also be added.

The atmosphere can be static over the reaction medium or flow in the form of a gas flow over the reaction mixture.

The flow rates used for this purpose can be (e.g. at a reactor volume of 2350 cm³) in the range from 0 ml to 1 l per minute, preferably 100-600 ml/min and particularly preferably 200 ml/min.

Heating of the reaction mixture can be carried out at various heating rates in the range from 1 to 20° C. per minute, with preference being given to using heating rates of 1-10° C./min and particularly preferably 3-5° C./min.

Furthermore, a stepwise carbonization process using various intermediate temperatures and heating rates is also possible.

After the target temperature has been reached, the reaction mixture is maintained at the temperature for a particular time or cooled immediately.

Advantageous hold times are from 30 minutes to 24 hours, preferably 2-10 hours and particularly preferably 2-3 hours.

Cooling can also be carried out actively or passively and also uniformly or stepwise.

The Si/C composite powders obtained in this way can be directly analytically characterized and used in the further electrode preparation or be after-treated mechanically, e.g. by milling or sieving processes, beforehand. Furthermore, it is also possible to use them for further surface modifications, e.g. by application of further C coatings.

The Si/C composite powders obtained can be obtained in the form of isolated particles, loose agglomerates or strong aggregates.

The Si/C particles can be spherical, splinter-shaped or else linear in the form of fibers or be present as ball-shaped tangles of fibers.

The average primary particle size of the composites can be <1 mm, preferably <20 μm and particularly preferably <10 μm.

The particle size distribution can be monomodal, bimodal or polymodal.

The amorphous carbon produced from lignin and optionally other C precursors can cover the silicon-based active material in the form of a thin layer or form a C matrix in which the silicon-based active material is internally embedded or present on the outside on the surface, and also combinations of these configuration possibilities. The C matrix can be very dense or else porous.

Both the silicon-based active material and the carbon in the Si/C composite can be crystalline or amorphous or contain mixtures of crystalline and amorphous constituents.

The Si/C composites can have low or else very high specific surface areas (BET) which can be in the range 0.1-400 m²/g (for the purposes of the present invention, preferably 100-200 m²/g).

The Si/C composites of the invention can have various chemical compositions.

In general, the Si/C composites can have Si contents of 10-90% by weight, C contents of 10-90% by weight, 0 contents of 0-20% by weight and N contents of 0-10% by weight. Preference is given to compositions made up of 20-50% by weight of Si, 50-80% by weight of C, 0-10% by weight of 0 and 0-10% by weight of N. Particular preference is given to compositions made up of 20-40% by weight of Si, 60-80% by weight of C, 0-5% by weight of 0 and 0-5% by weight of N. The carbon present can, depending on the composite composition, be made up of pure, amorphous carbon obtained by carbonization, conductive carbon black, graphite, carbon nanotubes (CNTs) and other carbon modifications.

Apart from the abovementioned main constituents, further chemical elements can also be present in the form of a deliberate addition or coincidental impurity: Li, Fe, Al, Cu, Ca, K, Na, S, Cl, Zr, Ti, Pt, Ni, Cr, Sn, Mg, Ag, Co, Zn, B, Sb; the contents thereof are preferably <1% by weight and particularly preferably <100 ppm.

The present invention further provides for the use of the Si composites of the invention as electrode material for lithium ion batteries.

The electrode materials of the invention are preferably used for producing the negative electrode of a lithium ion battery.

Here, the electrode materials of the invention are processed with further components and optionally a solvent such as water, hexane, toluene, tetrahydrofuran, N-methylpyrrolidone, N-ethylpyrrolidone, acetone, ethyl acetate, dimethyl sulfoxide, dimethylacetamide or ethanol or solvent mixtures to produce an electrode ink or paste.

The processing of the material can be carried out, for example, using rotor-stator machines, high-energy mills, planetary kneaders, stirred ball mills, shaking tables or ultrasonic devices.

For the purposes of the present invention, further components are storable materials such as graphite or lithium, polymeric binders or binder mixtures, conductive materials such as conductive carbon black, carbon nanotubes (CNT) or metal powders and further auxiliaries such as dispersants or pore formers. Possible binders are polyvinylidene fluoride, polytetrafluoroethylene, polyolefins or thermoplastic elastomers, in particular ethylene-propylene-diene terpolymers.

In a particular embodiment, modified cellulose is used as binder.

The solids content of the ink or paste is in the range from 5% by weight to 95% by weight, particularly preferably from 10% by weight to 50% by weight.

The electrode ink or paste comprising the composite materials of the invention is applied by means of a doctor blade in a dry layer thickness of from 2 μm to 500 μm, preferably from 10 μm to 300 μm, to a copper foil or another current collector.

Other coating methods such as spin coating, dipping, painting or spraying can likewise be used.

Before coating the copper foil with the electrode material of the invention, the copper foil can be treated with a commercial primer, e.g. one based on polymer resins. This increases the adhesion to the copper, but itself has virtually no electrochemical activity.

The electrode coating is dried to constant weight.

The drying temperature depends on the materials employed and the solvent used.

It is in the range from 20° C. to 300° C., particularly preferably from 50° C. to 150° C.

The proportion of the composite material according to the invention based on the dry weight of the electrode coating is in the range from 5% by weight to 98% by weight, particularly preferably from 60% by weight to 95% by weight.

The present invention further provides a lithium ion battery having a first electrode as cathode, a second electrode as anode, a membrane arranged between two electrodes as separator, two connections on the electrodes, a housing which accommodates the components mentioned and an electrolyte which contains lithium ions and with which the two electrodes are impregnated, where part of the second electrode contains the Si-containing composite material according to the invention.

As cathode material, it is possible to use lithium cobalt oxide, lithium nickel oxide, lithium nickel cobalt oxide (doped and undoped), lithium manganese oxide (spinel), lithium nickel cobalt manganese oxides, lithium nickel manganese oxides, lithium iron phosphate, lithium cobalt phosphate, lithium manganese phosphate, lithium vanadium phosphate or lithium vanadium oxides.

The separator is a membrane which is permeable only to ions, as is known in battery production. The separator separates the first electrode from the second electrode.

The electrolyte is a solution of a lithium salt (=electrolyte salt) in an aprotonic solvent. Electrolyte salts which can be used are, for example, lithium hexafluorophosphate, lithium hexafluoroarsenate, lithium perchlorate, lithium tetrafluoroborate, LiCF₃SO₃, LiN(CF₃SO₂) or lithium borates.

The concentration of the electrolyte salt is preferably from 0.5 mol/l to the solubility limit of the respective salt, but preferably 1 mol/1.

As solvents, it is possible to use cyclic carbonates, propylene carbonate, ethylene carbonate, dimethyl carbonate, diethyl carbonate, ethyl methyl carbonate, dimethoxyethane, diethoxyethane, tetrahydrofuran, 2-methyltetrahydrofuran, gamma-butyrolactone, dioxolane, acetonitrile, organic carbonic esters or nitriles, either individually or as mixtures thereof.

Even greater preference is given to the electrolyte containing a film former such as vinylene carbonate, fluoroethylene carbonate, etc., as a result of which a significant improvement in the cycling stability of the Si composite electrode can be achieved. This is mainly attributed to the formation of a solid electrolyte intermediate phase on the surface of active particles.

The proportion of the film former in the electrolyte can be in the range from 0.1% by weight to 20.0% by weight, preferably in the range from 0.2% by weight to 15.0% by weight, even more preferably from 0.5% by weight to 10% by weight.

Apart from the above-described liquid electrolyte systems, it is also possible to use solid electrolytes or gel electrolytes which comprise a solid phase of, for example, polyvinylidene fluoride, hexafluoropropylene, polyvinylidene fluoride-hexafluoropropylene copolymer, polyacrylonitrile, polymethyl methacrylate or polyethylene oxide, and also mixtures of these solid electrolytes with the above-mentioned liquid electrolyte phases.

The lithium ion battery of the invention can be produced in all usual forms in wound, folded or stacked form.

All substances and materials utilized for producing the lithium ion battery of the invention, as described above, are known.

The production of the parts of the battery of the invention and their assembly to form the battery of the invention are effected by the processes known in the field of battery production.

The invention is illustrated below with the aid of examples.

### EXAMPLES

Unless indicated otherwise, the examples below were carried out in an atmosphere of dry argon 5.0 and at the pressure of the surrounding atmosphere, i.e. about 1013 mbar, and at room temperature, i.e. at about 23° C.

The solvents used for the syntheses were dried by standard methods and stored under a dry argon atmosphere.

The following methods and materials were used in the examples:

Carbonization:

All carbonizations carried out in the examples were carried out using a 1200° C. three-zone tube furnace (TFZ 12/65/550/E301) from Carbolite GmbH using cascade regulation including a type N probe thermocouple.

The temperatures indicated are the internal temperature of the tube furnace at the position of the thermocouple.

The starting material to be carbonized in each case was weighed into one or more combustion boats made of fused silica (QCS GmbH) and introduced into a working tube made of fused silica (diameter 6 cm; length 83 cm).

The settings and process parameters used for the carbonizations are indicated in the respective examples.

Mechanical after-treatment/milling:

The Si/C powders obtained after the carbonization were subsequently comminuted further by milling using a planetary ball mill PM1000 from Retsch.

The Si/C powder was for this purpose introduced into a 50 ml milling cup (special steel or zirconium oxide) together with milling media (special steel or zirconium oxide; 10 or 20 mm diameter) and milled for a defined time at a preset speed of rotation (200 or 300 rpm).

The following analytical methods and instruments were used for characterizing the Si/C composite obtained:

### Scanning Electron Microscopy/Energy-Dispersive X-Ray Spectrometry (SEM/EDX):

The microscopic studies were carried out using a Zeiss Ultra 55 scanning electron microscope and an INCA x-sight energy-dispersive X-ray spectrometer.

A carbon coating was applied to the samples from the vapor phase by means of a Baltec SCD500 Sputter/carbon coating before examination in order to prevent charging phenomena.

Inorganic analysis/elemental analysis:

The C and, where applicable, S contents indicated in the examples were determined by means of a Leco CS 230 analyzer; a Leco TCH-600 analyzer was used for determining 0 and, where applicable, N and H contents.

The qualitative and quantitative determination of other elements indicated in the Si/C composites obtained was carried out after digestion using HNO₃/HF by means of inductively coupled plasma (ICP) emission spectroscopy using the Perkin Elmer Optima 7300 DV instrument.

The chlorine contents indicated were determined by means of ion chromatography.

### Particle Size Determination:

The determination of the particle size distribution indicated in the examples was carried out by means of a static laser light scattering on an LA-950 instrument from Horiba.

The Si/C composites were for this purpose dispersed in water with addition of octylphenoxypolyethoxyethanol (IGEPAL).

### Specific Surface Area by the BET Method:

The determination of the specific surface area of the Si/C composites obtained was carried out by the BET method using the Sorptomatic 1990 instrument from Thermo Fisher Scientific Inc.

Thermogravimetric analysis (TGA):

The ratio of various carbon modifications in a composite (especially graphite (G) in addition to amorphous carbon (a-C)) was determined by means of thermogravimetric analysis using a Mettler TGA 851 thermobalance.

The measurement was carried out under oxygen as measurement gas in the temperature range 25-1000° C. and at a heating rate of 10° C./min.

In the presence of G and a-C, the loss in mass caused by combustion of the total carbon takes place in two stages in the temperature range 400-800° C., from the ratio of which the a-C:G ratio indicated in the relevant examples was determined.

Materials Used:

The following materials were procured from commercial sources or synthesized in-house and used directly without further purification:

Silicon nanopowder (20-30 nm; Nanostructured & Amorphous Materials),

Silicon nanopowder dispersion (23% by weight in ethanol,
D₅₀=180 nm)

### Graphite KS6L-C (Timcal),

Carbon nanotubes (Baytubes C70P; Bayer Material Science),

### Polyacrylonitrile (Sigma Aldrich),

Dimethyl sulfoxide (Acros Organics),
Sodium dodecylsulfate (SDS; Sigma Aldrich).
Lignin was produced as aqueous-organic solvent from beech chips in an Organosolv process.
The digestion (180° C., 4 h) was carried out in 50% strength (v/v) aqueous-ethanolic solution using a liquor ratio of 4:1 (solvent:chips).

The lignin solution was separated from the fiber fraction by filtration.

The dark brown lignin solution obtained had a solids content of 4-7% by weight.

As an alternative, the corresponding digestion (170° C./2 h) was carried out in 50% strength (v/v) aqueous-ethanolic solution with an additional 1% by weight of H₂SO₄. Unless indicated otherwise, the H₂SO₄-free lignin solution was used in the following examples.

### Example 1

1.50 g of silicon nanopowder (20-30 nm; Nanostructured & Amorphous Materials) were introduced into 150 ml of lignin solution (7% by weight, in H₂O/EtOH) and treated in an ultrasonic bath for 1 hour. The volatile constituents were removed under reduced pressure and the brown residue was divided between two fused silica boats and carbonized under argon in a tube furnace: heating rate 10° C./min, temperature 800° C., hold time 2 h, Ar flow rate 200 ml/min. After cooling, 4.70 g of a black, pulverulent solid were obtained (carbonization yield 36%). The product was subsequently milled in a planetary ball mill: milling cup and milling media made of special steel; 1st milling: 3 balls (20 mm), 200 rpm, 1 h; 2nd milling: 12 balls (10 mm), 200 rpm, 1 h.

Elemental composition: Si 27% by weight, C 56% by weight, O 15% by weight, Li<10 ppm, Fe 0.34% by weight, Al<10 ppm, Cu<10 ppm, Ca 0.31% by weight, K 0.60% by weight, Na 250 ppm, S<0.1% by weight.

Particle size distribution: monomodal; D10: 3.83 μm, D50: 6.87 μm, D90: 10.7 μm.

Specific surface area (BET): 106 m²/g.

### Example 2

2.00 g of silicon nanopowder (20-30 nm; Nanostructured & Amorphous Materials) were introduced into 200 ml of lignin solution (7% by weight, in H₂O/EtOH) and the resulting dispersion was treated with ultrasound for 10 minutes. Water (200 ml), which had been freed of dissolved oxygen beforehand by passing argon through it, was added dropwise to the dispersion while stirring. The precipitated Si/lignin composite was separated off by filtration, washed a number of times with water and dried at 60° C. under reduced pressure (3.5 h). The brown residue was divided between two fused silica boats and carbonized under argon in a tube furnace: heating rate 10° C./min, temperature 800° C., hold time 2 h, Ar flow rate 200 ml/min. After cooling, 3.95 g of a black, pulverulent solid were obtained (carbonization yield 57%). The product was subsequently milled in a planetary ball mill: milling cup and milling media made of special steel; 3 balls (20 mm), 200 rpm, 2 h.

Elemental composition: Si 44% by weight, C 48% by weight, O 7% by weight, Li<10 ppm, Fe 0.10% by weight, Al 120 ppm, Cu<10 ppm, Ca 32 ppm, K 21 ppm, Na 46 ppm, S<0.1% by weight.

Particle size distribution: monomodal; D10: 0.65 μm, D50: 7.09 μm, D90: 14.2 μm.

Specific surface area (BET): 254 m²/g.

### Example 3

4.00 g of silicon nanopowder (20-30 nm; Nanostructured & Amorphous Materials) were introduced into 400 ml of lignin solution (7% by weight, in H₂O/EtOH) and the resulting dispersion was treated with ultrasound for 10 minutes. Water (400 ml), which had been freed of dissolved oxygen beforehand by passing argon through it, was added dropwise to the dispersion while stirring. The precipitated Si/lignin composite was separated off by filtration, washed a number of times with water and dried at 60° C. under reduced pressure (4.5 h). The brown residue was divided between two fused silica boats and carbonized in two stages under argon in a tube furnace:

Heating rate 2° C./min, temperature 300° C., hold time 2 h, Ar flow rate 200 ml/min. Carbonization yield in stage 1: 70%.

Heating rate 10° C./min, temperature 800° C., hold time 2 h, Ar flow rate 200 ml/min. Carbonization yield in stage 2: 89%.

After cooling, 6.25 g of a black, pulverulent solid were obtained (total carbonization yield 63%). The product was subsequently milled in a planetary ball mill: milling cup and milling media made of special steel; 3 balls (20 mm), 200 rpm, 3 h.

Elemental composition: Si 53% by weight, C 41% by weight, O 5% by weight, Li<10 ppm, Fe 143 ppm, Al 48 ppm, Cu<10 ppm, Ca 70 ppm, K 98 ppm, Na 110 ppm, S<0.1% by weight.

Particle size distribution: monomodal; D10: 0.75 μm, D50: 2.54 μm, D90: 5.56 μm.

Specific surface area (BET): 201 m²/g.

### Example 4

2.00 g of silicon nanopowder (20-30 nm; Nanostructured & Amorphous Materials) and 3 g of graphite (Timcal) were introduced into 180 ml of lignin solution (7% by weight, in H₂O/EtOH) and the resulting dispersion was treated with ultrasound for 15 minutes. Water (180 ml) which had been freed of dissolved oxygen beforehand by passing argon through it, was added dropwise to the dispersion while stirring. The precipitated Si/graphite/lignin composite was separated off by filtration, washed a number of times with water and dried at 60° C. under reduced pressure (4 h). The black-brown residue was placed in a fused silica boat and carbonized under argon in a tube furnace: firstly heating rate 2° C./min, temperature 300° C., hold time 2 h, Ar flow rate 200 ml/min; then immediately further at heating rate 10° C./min, temperature 800° C., hold time 2 h, Ar flow rate 200 ml/min. After cooling, 6.00 g of a black, pulverulent solid were obtained (carbonization yield 76%). The product was comminuted manually in a mortar.

Elemental composition: Si 30% by weight, C 66% by weight (G 44% by weight; a-C 22% by weight), O 3% by weight, Li<10 ppm, Fe 15 ppm, Al 17 ppm, Cu<10 ppm, Ca 17 ppm, K 19 ppm, Na 20 ppm, S<0.1% by weight.

Particle size distribution: monomodal; D10: 3.04 μm, D50: 5.31 μm, D90: 8.72 μm.

Specific surface area (BET): 101 m²/g.

### Example 5

18.0 g of silicon nanopowder dispersion (23% by weight in ethanol, D₅₀=180 nm) and 400 ml of lignin solution (7% by weight, in H₂O/EtOH) were mixed with one another with stirring. Water (450 ml), which had been freed of dissolved oxygen beforehand by passing argon through it, was added dropwise to the dispersion while stirring. The precipitated Si/lignin composite was separated off by filtration, washed a number of times with water and dried at 60° C. under reduced pressure (4.5 h). The brown residue was divided between two fused silica boats and carbonized under argon in a tube furnace: firstly heating rate 3° C./min, temperature 300° C., hold time 1 h, Ar flow rate 200 ml/min; then immediately further at heating rate 10° C./min, temperature 800° C., hold time 2 h, Ar flow rate 200 ml/min. After cooling, 5.04 g of a black, pulverulent solid were obtained (carbonization yield 49%). The product was firstly comminuted manually in a mortar and subsequently milled in a planetary ball mill: milling cup and milling media made of special steel; 3 balls (20 mm), 200 rpm, 2 h.

Elemental composition: Si 48% by weight, C 43% by weight, O 8% by weight, N 0.2% by weight, H 0.5% by weight, Li<10 ppm, Fe 440 ppm, Al<100 ppm, Cu<10 ppm, Ca 240 ppm, K 34 ppm.

Particle size distribution: monomodal; D10: 0.62 μm, D50: 2.56 μm, D90: 5.53 μm.

Specific surface area (BET): 206 m²/g.

### Example 6

1.70 g of silicon nanopowder (20-30 nm; Nanostructured & Amorphous Materials) and 2.60 g of carbon nanotubes were introduced into 155 ml of lignin solution (7% by weight, in H₂O/EtOH) and the resulting dispersion was firstly admixed with a spatula tip of sodium dodecylsulfate (SDS) and subsequently treated with ultrasound for 25 minutes. Water (200 ml), which had been freed of dissolved oxygen beforehand by passing argon through it, was added dropwise to the dispersion while stirring. The precipitated Si/CNT/lignin composite was separated off by filtration, washed a number of times with water and dried at 60° C. under reduced pressure (4.5 h). The black-brown residue was placed in a fused silica boat and carbonized under argon in a tube furnace: firstly heating rate 2° C./min, temperature 300° C., hold time 2 h, Ar flow rate 200 ml/min; then immediately further at heating rate 10° C./min, temperature 800° C., hold time 2 h, Ar flow rate 200 ml/min. After cooling, 5.72 g of a black, pulverulent solid were obtained (carbonization yield 25%). The product was subsequently milled in a planetary ball mill: milling cup and milling media of zirconium oxide; 3 balls (20 mm), 300 rpm, 2 h.

Elemental composition: Si 29% by weight, C 54% by weight (CNT 44% by weight; a-C 10% by weight), O 17% by weight, Li<10 ppm, Fe 20 ppm, Al 0.13% by weight, Cu 15 ppm, Ca 130 ppm, K 70 ppm, Zr 40 ppm, S<0.1% by weight.

Particle size distribution: bimodal; D10: 0.14 μm, D50: 0.45 μm, D90: 2.19 μm.

Specific surface area (BET): 231 m²/g.

### Example 7

### a)

4.00 g of silicon nanopowder (20-30 nm; Nanostructured & Amorphous Materials) were introduced into 400 ml of lignin solution (7% by weight, in H₂O/EtOH) and the resulting dispersion was treated with ultrasound for 15 minutes. Water (400 ml), which had been freed of dissolved oxygen beforehand by passing argon through it, was added dropwise to the dispersion while stirring. The precipitated Si/lignin composite was separated off by filtration, washed a number of times with water and dried at 60° C. under reduced pressure (4.5 h). The brown residue was placed in a fused silica boat and carbonized under argon in a tube furnace: firstly heating rate 3° C./min, temperature 300° C., hold time 2 h, Ar flow rate 200 ml/min; then immediately further at heating rate 10° C./min, temperature 800° C., hold time 2 h, Ar flow rate 200 ml/min. After cooling, 6.33 g of a black, pulverulent solid were obtained (carbonization yield 51%). The product was subsequently milled in a planetary ball mill: milling cup and milling media made of special steel;

12 balls (10 mm), 200 rpm, 2 h.
Particle size distribution: bimodal; D10: 0.14 μm, D50: 0.91 μm, D90: 5.75 μm.

### b)

4.00 g of polyacrylonitrile (PAN) were dissolved in 60 ml of water-free dimethyl sulfoxide by stirring at room temperature. The Si/C composite produced in a) (6.05 g) was introduced into the PAN solution while stirring and the resulting dispersion was treated in an ultrasonic bath for 1 hour. The volatile constituents were removed at 80-90° C. under reduced pressure. The rubber-like residue was comminuted, divided between two fused silica boats and carbonized under argon in a tube furnace: firstly heating rate 3° C./min, temperature 280° C., hold time 1.5 h, Ar flow rate 200 ml/min; then immediately further at heating rate 10° C./min, temperature 800° C., hold time 2 h, Ar flow rate 200 ml/min. After cooling, 7.29 g of a black, pulverulent solid were obtained (carbonization yield 72%). The product was subsequently milled in a planetary ball mill: milling cup and milling media made of zirconium oxide; 3 balls (20 mm), 300 rpm, 2 h.

Elemental composition: Si 38% by weight, C 51% by weight, O 7% by weight, N 4% by weight, Li<10 ppm, Fe 670 ppm, Al 61 ppm, Cu 35 ppm, Ca 90 ppm, K 54 ppm, Zr 400 ppm.

Particle size distribution: monomodal; D10:1.24 μm, D50: 4.34 μm, D90: 8.61 μm.

Specific surface area (BET): 105 m²/g.

### Example 8

1.18 g of the composite material from example 4 and 0.18 g of conductive carbon black (Timcal, Super P Li) were dispersed in 11.4 g of a 1.0% strength by weight solution of sodium carboxymethylcellulose (Daicel, Grade 1380) in water by means of a high-speed mixer at a circumferential velocity of 12 m/s. After degassing, the dispersion was applied by means of a film drawing frame having a gap height of 0.25 mm (Erichsen, model 360) to a copper foil (Schlenk Metallfolien, SE-Cu58) having a thickness of 0.030 mm. The electrode coating produced in this way was subsequently dried at 80° C. for 60 minutes. The average weight per unit area of the electrode coating is 2.35 mg/cm².

### Example 9

The electrochemical studies were carried out on a half cell in a three-electrode arrangement (zero-current potential measurement). The electrode coating from example 8 was used as working electrode, lithium foil (Rockwood Lithium, thickness 0.5 mm) was used as reference electrode and counterelectrode. A 6-layer nonwoven stack (Freudenberg Vliesstoffe, FS2226E) impregnated with 100 μl of electrolyte served as separator. The electrolyte used consisted of a 1 molar solution of lithium hexafluorophosphate in a 3:7 (v/v) mixture of ethylene carbonate and diethyl carbonate which had been admixed with 2% by weight of vinylene carbonate. The construction of the cell took place in a glove box (<1 ppm H₂O, O₂), and the water content in the dry matter of all components used was below 20 ppm.

Electrochemical testing was carried out at 20° C. The potential limits used were 40 mV and 1.0 V vs. The charging or lithiation of the electrode was carried out by the cc/cv (constant current/constant voltage) method at constant current and after reaching the voltage limit at constant voltage until the current went below 50 mA/g. Discharging or delithiation of the electrode was carried out by the cc (constant current) method using a constant current until the voltage limit was reached. The specific current selected was based on the weight of the electrode coating.

### BRIEF DESCRIPTION OF THE DRAWINGS

Reference is made below to FIGS. 1 and 2.

FIG. 1 shows the charging (broken line) and discharging capacity (solid line) of the electrode coating from example 8 as a function of the number of cycles at a current of 100 mA/g.

The electrode coating from example 8 displays a reversible capacity of about 700 mAh/g, which corresponds to a capacity of the composite material from example 4 of 875 mAh/g.

FIG. 2 shows the discharging capacity of the electrode coating as a function of the discharging current at a constant charging current of 100 mA/g.

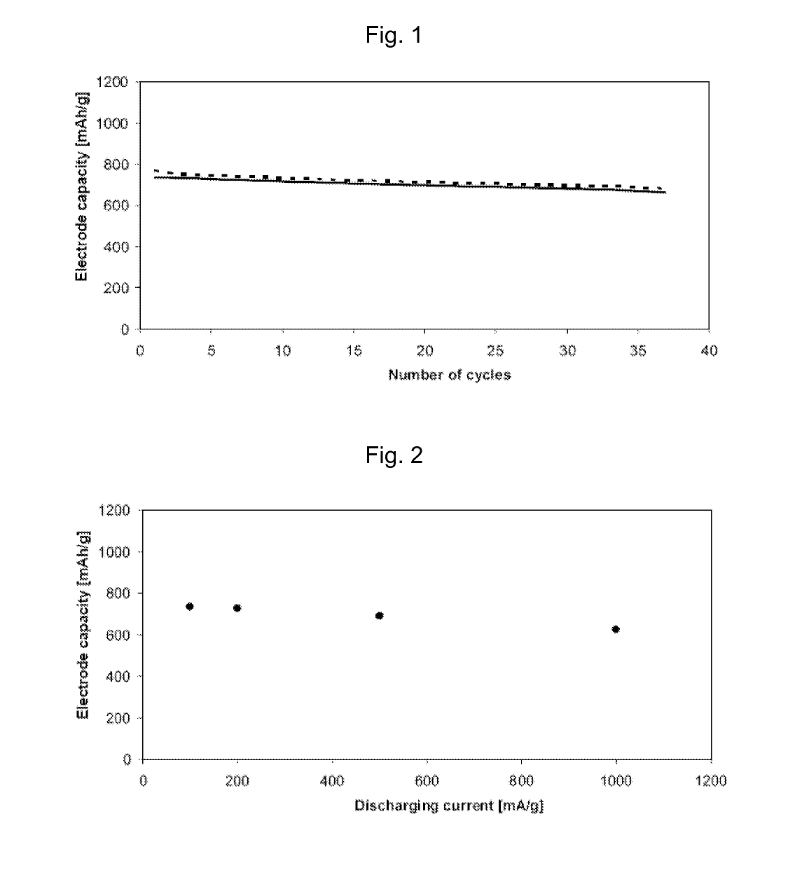

The reversible capacity of the electrode coating as per example 8 is virtually independent of the prescribed specific current up to 1000 mA/g.

### Comparative Example 1

### Not According to the Invention

2.00 g of silicon nanopowder (20-30 nm; Nanostructured & Amorphous Materials) were introduced into a solution of 16 ml of ethanol and 160 ml of water with vigorous stirring and treated in an ultrasonic bath for 30 minutes. Ammonia solution (32%, 625 μl) and resorcinol (1.60 g) were added and the dispersion was stirred at room temperature for 30 minutes until all the resorcinol had gone into solution. Formaldehyde solution (37% by weight in water stabilized with 10% by weight of methanol; 2.36 g) was added and the reaction mixture was firstly stirred at 30° C. for 30 minutes and subsequently heated at 60° C. for 10 hours. After cooling to room temperature, the silicon-containing particles were separated off from the dispersion medium by centrifugation (5000 rpm, 30 min, 23° C.), redispersed in a total of 125 ml of ethanol, centrifuged again and washed with 4×25 ml of ethanol. The combined particles were freed of the solvent at 80° C. under reduced pressure (3.5×10⁻² mbar) and the solid residue obtained was dried for 2 hours in vacuo. The brown residue was placed in a fused silica boat and carbonized under argon in a tube furnace: heating rate 5° C./min, temperature 650° C., hold time 3 h, Ar flow rate 200 ml/min. After cooling, 1.78 g of a black, pulverulent solid were obtained (carbonization yield 63%).

Elemental composition: Si 36% by weight, C 42% by weight, O 22% by weight, Li<10 ppm, Fe 15 ppm, Al 39 ppm, Cu<10 ppm, Ca 15 ppm, K 17 ppm, Cl<3 ppm.

Specific surface area (BET): 322 m²/g.

The Si/C material from comparative example 1 displays a significantly higher O content (>20% by weight) compared to examples 1-7 according to the invention.

The present invention makes it possible to obtain Si/C composites as anode active materials for lithium ion batteries, which compared to the prior art have a carbon matrix having great strength and elasticity and thus have improved cycling stability, especially in comparison with a physical mixture of silicon and carbon having a comparable composition.

This was made possible by the use of the naturally occurring biopolymer lignin as precursor for producing a carbon coating or matrix rather than established C precursors based on hydrocarbons, carbohydrates or organic polymers for embedding the active silicon-containing particles in carbon and thus effects electrochemical stabilization.

It has surprisingly been found that the production of Si/C composites from lignin as C precursor and the use of the materials obtained as anode active materials in lithium ion batteries have a number of advantages over other Si/C composites based on established C precursors.

Compared to hydrocarbon precursors, which are mostly used in the form of highly toxic polyaromatic compounds based on pitches or tars, lignin is, as natural material, nontoxic and not tied to a petrochemical raw materials source.

Furthermore, lignin is readily soluble in polar solvents such as water/alcohol mixtures, while established pitch precursors often contain insoluble constituents and can be processed only in the melt or in nonpolar solvents, which can frequently be a complication and thus undesirable in production processes.

Compared to C precursors based on carbohydrates such as sugars and celluloses, which are also readily soluble and processable in polar protic solvents, lignin and the carbon materials obtained from lignin have a significantly lower oxygen content, as a result of which oxidation of the silicon surface in the composite can be largely minimized.

Advantages over polymeric, thermoplastic C precursors (e.g. vinyl polymers such as PVC) are given, in particular, by the significantly higher carbon yields from lignin in the carbonization.

Although lignin has, as highly branched polyphenol, many structural analogies with phenolic and resorcinol resins, it is, in contrast to the resins mentioned, not produced from petrochemical starting materials but on the basis of renewable vegetable raw materials and therefore offers a sustainable alternative which is not based on petroleum and thus conserves resources to established polymeric, thermoset C precursors.

The solid, crosslinked and low-oxygen carbon produced by carbonization of lignin serves as stabilizing matrix in order to structurally accommodate the extreme volume expansion of silicon during charging and thus minimize mechanical destruction of the active material and of the electrode structure with losses of capacity over a plurality of charging and discharging cycles.

Furthermore, the carbon protects the surface of the silicon-based active material from reactions with other constituents of the electrode or of the battery cell and thus additionally minimizes lithium losses.

This gives an Si/C composite material which displays significantly improved electrochemical behavior compared to a physical mixture of silicon and carbon having a comparable composition.

What is claimed is:

1. A process for producing an Si/C composite, which comprises:
providing an active material containing silicon;
providing lignin;
bringing the active material into contact with a C precursor containing lignin; and
converting lignin into inorganic carbon at a temperature of at least 400° C. in an inert gas atmosphere.

2. The process as claimed in claim 1, wherein the active material comprises elemental silicon, a silicon oxide or a silicon-metal alloy.

3. The process as claimed in claim 1, wherein the active material comprises microsize or nanosize silicon particles.

4. The process as claimed in claim 1, wherein the active material and the C precursor are brought into contact by being milled or physically mixed.

5. The process as claimed in claim 1, wherein the contacting of active material and C precursor is effected by dispersing the active material in a dispersion or solution of lignin and coating the active material with lignin or embedding the active material in lignin by subsequent removal of a solvent.

6. The process as claimed in claim 3, wherein the contacting of active material and C precursor is effected by depositing silicon particles on the C precursor or depositing the C precursor on the silicon particles by chemical or thermal vapor deposition.

7. The process as claimed in claim 1, wherein the lignin is converted into inorganic carbon by heating to a target temperature of 400-1400° C., thermal treatment at the target temperature for at least 30 minutes and subsequent cooling.

8. An Si/C composite containing 10-90% by weight of silicon and 10-90% by weight of carbon and having an average size of less than 1 mm, wherein the carbon originates at least partly from lignin.

9. An Si/C composite produced by a process as claimed in claim 1, wherein the composite comprises 10-90% by weight of silicon and 10-90% by weight of carbon and has an average size of less than 1 mm.

10. The Si/C composite as claimed in claim 8, comprising carbon-coated silicon particles.

11. The Si/C composite as claimed in claim 8, containing a carbon matrix in which silicon particles are embedded.

12. An anode material for a lithium ion battery, which contains an Si/C composite as claimed in claim 8.

13. A process for producing an anode for a lithium ion battery, which comprises:
processing the anode material as claimed in claim 12 to form an ink or paste having a solids content of 5-95% by weight;
applying the ink or paste in a dry layer thickness of 2-500 μm to a current collector; and
drying the ink or paste on the current collector at a temperature of 20-300° C.,
wherein the proportion of the anode material based on a dry weight of the ink or paste is 5-98% by weight.

14. The process as claimed in claim 13, wherein the anode material is processed with one or more constituents selected from the group consisting of graphite, lithium, binders, conductive carbon black, carbon nanotubes, metal powder, dispersant, pore former and solvent to form an ink or paste.

15. A lithium ion battery comprising a cathode, an anode, a membrane as separator arranged between cathode and anode, and an electrolyte containing lithium ions, wherein the anode contains an anode material as claimed in claim 12.

16. The process as claimed in claim 2, wherein the active material comprises nanosize Si particles having an average particle size of less than 500 nm.

17. The process as claimed in claim 16, wherein the active material and the C precursor are brought into contact by being milled or physically mixed.

18. The process as claimed in claim 16, wherein the contacting of active material and C precursor is effected by dispersing the active material in a dispersion or solution of lignin and coating the active material with lignin or embedding the active material in lignin by subsequent removal of a solvent.

19. The process as claimed in claim 16, wherein the contacting of active material and C precursor is effected by depositing silicon particles on the C precursor or depositing the C precursor on the silicon particles by chemical or thermal vapor deposition.

20. The process as claimed in claim 16, wherein the lignin is converted into inorganic carbon by heating to a target temperature of 400-1400° C., thermal treatment at the target temperature for at least 30 minutes and subsequent cooling.
